(19) United States
(12) Patent Application Publication
(10) Pub. No.: US 2014/0286673 A1
(43) Pub. Date: Sep. 25, 2014

(54) DEVELOPMENT DEVICE, IMAGE FORMING UNIT, AND IMAGE FORMING APPARATUS

(71) Applicant: Oki Data Corporation, Tokyo (JP)

(72) Inventor: Atsushi OTA, Tokyo (JP)

(73) Assignee: Oki Data Corporation, Tokyo (JP)

(21) Appl. No.: 14/219,524

(22) Filed: Mar. 19, 2014

(30) Foreign Application Priority Data
Mar. 25, 2013 (JP) 2013-061356

(51) Int. Cl. G03G 15/08

(52) U.S. Cl. CPC G03G 15/0881
USPC 399/103

(57) ABSTRACT

A development device includes a developer container that includes a developer chamber configured to contain a developer, a developer carrier configured to hold the developer on a surface of an outer periphery and configured to rotate about an axis, and faces an electrostatic latent image carrier that carries an electrostatic latent image, a longitudinal sealing member configured to contact the surface of the developer carrier in the long-side direction and configured to provide a seal of the developer from between the developer container and the developer carrier, and a capture unit configured to capture the developer from between the longitudinal sealing member and the developer carrier.

This application claims priority under 35 U.S.C. §119 from Japanese Patent Application No. P 2013-061356, filed on Mar. 25, 2013, the disclosure of which is incorporated herein by reference.

### BACKGROUND OF THE INVENTION

1. Field of the Invention

This application relates to a development device, an image forming unit, and an image forming apparatus.

2. Description of Related Art

Generally, an image forming apparatus such as a printer, copier or facsimile machine is configured to form an image by uniformly charging a surface of a photosensitive drum, exposing the surface of the photosensitive drum to form a latent image, developing the latent image using a toner (as a developer) to form a toner image, transferring the toner image to a recording medium, and fixing the toner image to the recording medium. The photosensitive drum, a charging device, a development device, and the like may constitute an image forming unit.

Japanese patent publication 2005-208250 describes a development device that includes a sealing member to prevent leakage of the developer from a developer container.

However, the developer in the developer container leaks through the sealing member, when there is, for example, an impact shock to the development device.

### SUMMARY OF THE INVENTION

In view of the above, a development device is disclosed.

In particular, a development device includes a developer container that includes a developer chamber configured to contain a developer, a developer carrier configured to hold the developer on a surface of an outer periphery and configured to rotate about an axis, and faces an electrostatic latent image carrier that carries an electrostatic latent image, a longitudinal sealing member configured to contact the surface of the developer carrier in the long-side direction and configured to provide a seal of the developer from between the developer container and the developer carrier, and a capture unit configured to capture the developer from between the longitudinal sealing member and the developer carrier.

### BRIEF DESCRIPTION OF THE DRAWINGS

FIG. 1 is a schematic view showing the configuration of an image forming apparatus according to a first illustrative embodiment;

FIG. 2 is a perspective view showing a sealing structure;

FIG. 3 is a sectional view showing the sealing structure;

FIG. 4 is a sectional view showing a sealing structure according to a variation of the first illustrative embodiment;

FIG. 5 is a sectional view showing an image forming unit according to a comparative example;

FIG. 6 is a perspective view showing a sealing structure according to the comparative example;

FIG. 7 is a sectional view showing an image forming apparatus according to a second illustrative embodiment;

FIG. 8 is an exploded perspective view showing a development device according to a second illustrative embodiment.

### DETAILED DESCRIPTION

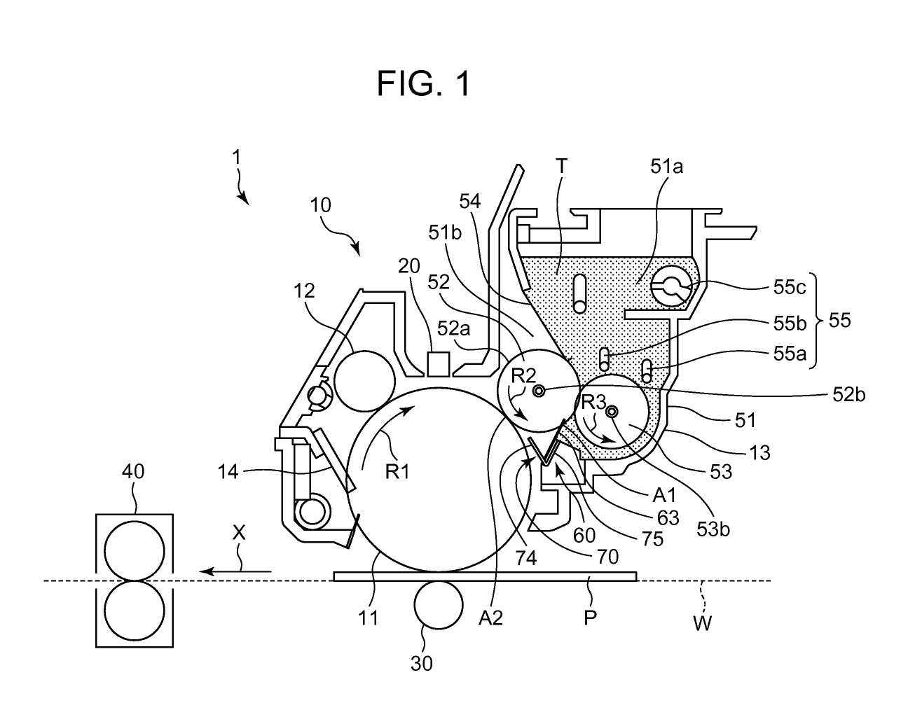

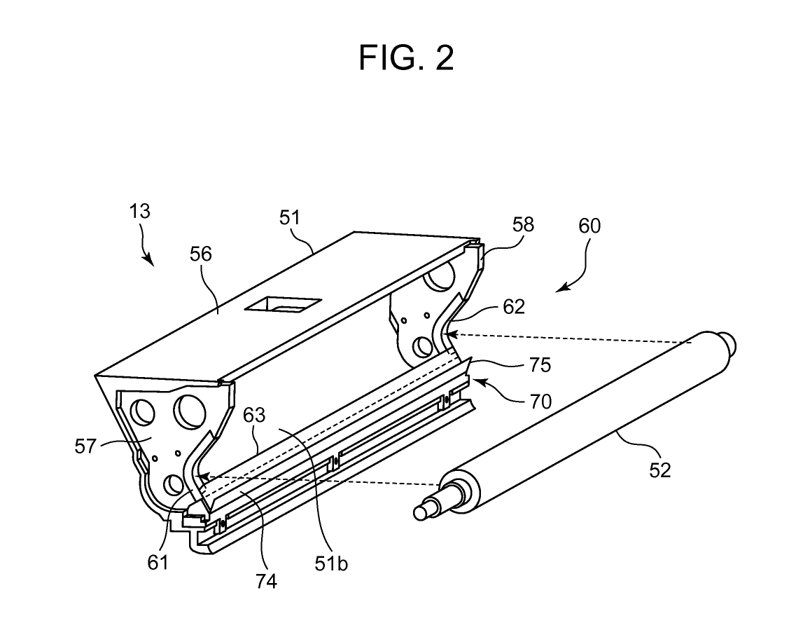

Embodiments of the image forming apparatus will be described with reference to FIGS. 1 to 8 of the drawings, in which like elements are indicated by like reference characters. In the drawings, configurations, positional relations, dimensions, and alignments of elements of the device are illustrated generally for understanding the embodiments and are only intended to facilitate understanding. Described numerical values are merely exemplary. In the drawings, common elements of structures may be designated by the same reference characters, and an explanation thereof is occasionally omitted. Accordingly, embodiments are in no way limited to those illustrated.

The configuration of a first illustrative embodiment of the image forming apparatus 1 is shown FIG. 1. The image forming apparatus 1 is an apparatus that forms image on a medium with using a developer in the electrographic system, and the apparatus is a printer here.

The image forming apparatus 1 includes an image developing unit (ID unit) 10, an exposure device 20, a transfer roller 30 as a transfer device, and a fuser device 40.

The ID unit 10 is a detachable unit that forms developer image, and is installed in the image forming apparatus 1. The ID unit 10 includes a photosensitive drum 11 as an electrostatic latent image carrier, a charging roller 12, a development device 13, and a cleaning blade 14 as a cleaning device.

The photoconductor drum 11 holds an electrostatic latent image and a developer image formed on the surface. The photosensitive drum 11 extends in a direction perpendicular to the drawing illustrated in FIG. 1, and is a cylindrical member. The photosensitive drum 11 is rotary drum and arranged in the image forming apparatus 1. When a process is image forming, the photosensitive drum 11 rotates in the direction of arrow R1.

Around the photosensitive drum 11, a charging roller 12 as a charging device, an exposure device 20, development device 13, a transfer roller 30, and a cleaning blade 14 are arranged along the rotary direction of arrow R1.

The charging roller 12 is configured to charge the surface of the photosensitive drum 11. The exposure device 20 is configured to selectively emit light to the surface of the photosensitive drum 11 to thereby form an electrostatic latent image. The development device 13 is configured to develop the electrostatic latent image on the surface of the photosensitive drum 11 using a toner T as a developer, and form a toner image as a developer image. A toner image that is formed on the surface of the photosensitive drum 11 is transferred to the sheet P. The cleaning blade 14 scrapes off (i.e., removes) the toner adhering to the surface of the photosensitive drum 11 after the transferring to the sheet P.

The fuser device 40 is arranged in a downstream side from the photosensitive drum 11 (FIG. 1). In horizontal axis, a left side is a downstream side, and a right side is an upstream side (FIG. 1). So, if element locates relatively in the left side, the element locates downstream. The fuser device 40 causes the toner image to be fixed to the sheet P.

The exposure device 20, the transfer roller 30, and the fuser device 40 are arranged in main body of the image forming apparatus 1. The image forming apparatus 1 includes, for example, a sheet feeding tray (not shown) that contains one or more sheet(s) and a sheet carrying mechanism (not shown) to carry the sheet P that is picked up from the sheet feeding tray along a carrying pass W.

The constitution of the development device 13 is described below.

The development device 13 includes a developing roller 52 as a developer carrier, a developer supply roller 53 as a developer supplying member, a developing blade 54 as a developer regulation member, and a stirring device 55.

The developer container 51 includes a developer chamber 51a as a developer container that contains the toner T and an aperture part 51b that faces the photosensitive drum 11.

The developing roller 52 holds the toner T on an outer periphery 52a and carries to the photosensitive drum 11. The developing roller 52 is arranged so as to face or contact the photosensitive drum 11. The developing roller 52 supplies the toner T to an electrostatic latent image on the photosensitive drum 11 and develops the electrostatic latent image with the toner T. The developing roller 52 extends in a long-side direction, and is a cylindrical member. The developing roller 52 is arranged so as to be parallel to the long-side direction of the photosensitive drum 11. The developing roller 52 faces the developer chamber 51a and rotates on an axis of developing axis 52b as a rotation axis. The developing roller 52 is arranged in close to the aperture part 51b.

The developer supply roller 53 supplies the toner T in the developer container 51 to the developing roller 52. The developer supply roller 53 is arranged so as to face or contact the developing roller 52. The developer supply roller 53 is parallel to the developing roller 52 and extends in the long-side direction of the developing roller 52. The developer supply roller 53 is a cylindrical member. The developing roller 53 faces the developer chamber 51a and rotates on an axis of supplying axis 53b as a rotation axis. When a process is image forming, the developer supply roller 53 rotates in the direction of arrow R3.

The developing blade 54 controls amount of a toner T on the developing roller 52. The developing blade 54 thins a toner T that is supplied from the developer supply roller 53 to the developing roller 52. The developing blade 54 is located in the downstream side compared with the developer supply roller 53, and the developing blade 54 is located in the upstream side compared with the photosensitive drum 11. The developing blade 54 is arranged so as to face or contact the developing roller 52.

The stirring device 55 stirs a toner T in the developer container 51. The stirring device 55 includes stirring members 55a, 55b, and 55c that are arranged so as to rotate in the developer chamber 51a.

The development device 13 includes a sealing structure 60 that prevents leakage of the toner T from the developer chamber 51a.

A processing of the image forming apparatus 1 when it forms image is described below. When a processing that forms image starts, the photosensitive drum 11 rotates in the direction of the arrow R1(FIG. 1). A surface of the photosensitive drum 11 is uniformly charged by the charging roller 12. After the charging by the charging roller 12, the surface of the photosensitive drum 11 is exposed by exposure device 20, and the electrostatic latent image forms on the surface of the photosensitive drum 11.

The electrostatic latent image on the photosensitive drum 11 is developed by the development device 13. In the development device 13, the developer supply roller 53 rotates in the direction of the arrow R2 (FIG. 1), and the developer supply roller 53 supplies the toner T in the developer chamber 51a to the developing roller 52. The toner T on the developing roller 52 is carried according to the rotation by the developing roller 52, and supplied to the electrostatic latent image on the photosensitive drum 11 after the thinning of the toner T by the developing blade 54. As a result, the toner image on the photosensitive drum 11 forms.

The sheet P is carried along the carrying path W so as to pass the transfer roller 30 and the fuser device 40 after a sheet carrying mechanism (not shown) picks the sheet P up from a sheet tray (not shown).

When the sheet P passes the transfer roller 30, the toner image on the photosensitive drum 11 is transferred to the sheet P by the transfer roller 30. Next, the toner image on the sheet P is fused by the fuser device 40 when the sheet P passes the fuser device 40. The sheet P after the fusing by the fuser device 40 is ejected to an ejection tray (not shown).

In the image forming process, some of the toner T in the developer chamber 51a is ejected externally when the toner T is supplied to the photosensitive drum 11. The development device 13 includes a sealing to prevent external leakage of the toner T except for the external ejection.

Referring to the FIGS. 1 to 3, the sealing structure 60 is described below. In addition, up, down, left, right, rear, and front in the description indicate up, down, left, right, rear, and front for a user when the user sees the development device 13 from the photosensitive drum 11 in a use situation of an image forming apparatus.

The sealing structure 60 includes an edge sealing member 61, an edge sealing member 62, and a longitudinal sealing member 63.

The edge sealing members 61, 62 are contacted and pressed at edge parts that are both sides in the long-side direction of the developing roller 52, and the edge sealing members 61, 62 prevent leakage of the toner T between edges of the developing roller 52 and the developer container 51. The edge sealing member 61 contacts an edge part of a left side in the aperture part 51b. Thus, an opening between the left side of the developer container 51 and the developing roller 52 is filled up to prevent leakage of the toner T from the opening or the edge part of the left side in the aperture part 51b. The edge sealing member 62 contacts an edge part of a right side in the aperture part 51b. Thus, an opening between the right side of the developer container 51 and the developing roller 52 is filled up to prevent leakage of the toner T from the opening or the edge part of the right side in the aperture part 51b.

The longitudinal sealing member 63 is contacted and pressed at the outer periphery 52a in the long-side direction of the developing roller 52. The longitudinal sealing member 63 prevents leakage of the toner T between the developing roller 52 and the developer container 51. The longitudinal sealing member 63 is arranged at a set position in the long-side direction of the developing roller 52. The longitudinal sealing member 63 extends in the long-side direction of the developing roller 52. In particular, the longitudinal sealing member 63 is contacted and pressed at an abutting part A1 in the outer periphery 52a. Thus, the longitudinal sealing member 63 fills up an opening between the developing roller 52 and the developer container 51. The longitudinal sealing member 63 is arranged at whole length of the aperture part 51b in the long-side direction, and arranged in the lower side of the developing roller 52. Thus, the longitudinal sealing member 63 prevents leakage of the toner T in the lower side of the developing roller 52. For example, the longitudinal sealing member 63 is a plate that extends in both sides direction of the long-side direction and a short-side direction that is perpendicular to the long-side direction, and both a right and left edges of the longitudinal sealing member 63 ride the edge sealing member 61, 62. An edge of one side of the longitudinal sealing member 63 in the short-side direction is fixed to the developer container 51, and an edge of another side of the longitudinal sealing member 63 in the short-side direction is arranged so as to be contacted and pressed at the outer periphery 52a. The longitudinal sealing member 63 may be flexible, and may be contacted and pressed at the outer periphery 52a with flexibility.

An opening in the upper side of the developing roller 52 or an upper side of the aperture part 51b is sealed by the developing blade 54.

When the developer container 51 bends by an impact, the toner T in the developer chamber 51a passes through the longitudinal sealing member 63.

Even though the toner T in the developer container 51 passes through the longitudinal sealing member 63, the image forming apparatus 1 curbs leakage of the toner T toward external device, for example, the exposure device 20. Thus, the development device 13 includes a capture unit 70 that captures a leaked toner T from the abutting part A1. The capture unit 70 is arranged in a more downstream side than the longitudinal sealing member 63 is arranged, and may face developing roller 52.

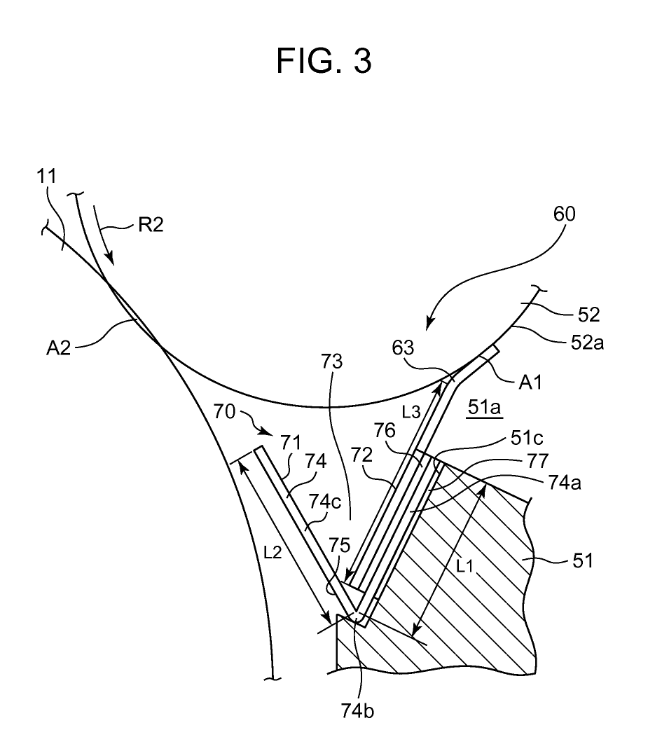

As shown in FIG. 3, the capture unit 70 includes a first wall surface 71 and a second wall surface 72 that extends in direction to the abutting part A1. The first wall surface 71 and the second wall surface 72 extend in direction to the long-side direction of the developing roller 52. The first wall surface 71 faces the second wall surface 72 beginning at an edge part 74b. A containing space 73 that contains a toner T becomes around the first wall surface 71 and the second wall surface 72. The first wall surface 71 is arranged in an opposite side of the developer container 51, and extends in the direction to the developing roller 52. The first wall surface 71 does not extend until it contacts the developing roller 52 and the photosensitive drum 11. The second wall surface 72 may contact the outer periphery 52a, and is made of the longitudinal sealing member 63. In circular axis R2, if the element locates relatively in a left side, the element locates in a upstream side (FIG. 3). So, compared the first wall surface 71 with the abutting part A1, the first wall surface 71 locates in an upstream side. Compared the first wall surface 71 with the abutting part A1, the first wall surface 71 extends in the upstream direction. Compared the first wall surface 71 with the second wall surface 72, the second wall surface 72 locates in a downstream side. The second wall surface 72 may extend along the outer periphery 52a in the downstream direction, and a part of the second wall surface 72 may contact the outer periphery 52a at the abutting part A1.

The capture unit 70 includes a capture member 74. The capture member 74 captures a toner T that leaks from the abutting part A1. The capture member 74 has a function as, for example, a developer scattering preventing member that prevent scattering the leaked toner to the development device 13. A set space becomes around the capture member 74 and the outer periphery 52a. The capture member 74 is arranged in an opposite side of the abutting part A1 from the developer container 51, and extends in a direction to a far side of the abutting part A1 beginning at the edge part 74b. The capture member 74 does not extend until it contacts the developing roller 52 and the photosensitive drum 11. The capture member 74 extends along the long-side direction of the developing roller 52. A length of the capture member 74 may be same length of the longitudinal sealing member 63 in the long-side direction. The first wall surface 71 is made of the capture member 74.

The capture member 74 and the longitudinal sealing member 63 are constituted integrally. An opposite side of the side that contacts with the abutting part A1 in the longitudinal sealing member 63 may be formed so as to extend in the upstream direction of the outer periphery 52a. The capture member 74 and the longitudinal sealing member 63 are fixed with, for example, an adhesive as a sealing member 75. The sealing member 75 and the developer container 51 are fixed with, for example, an adhesive. The capture member 74 may have a function that reinforces the longitudinal sealing member 63 as a reinforced member.

As shown in FIG. 3, the capture member 74 includes a fixing unit 74a and an out-thrust wall 74c. The fixing unit 74a extends along the longitudinal sealing member 63 and in the downstream direction of the outer periphery 52a. The out-thrust wall 74c may thrust in the upstream direction of the outer periphery 52a beginning at the edge part 74b. For example, the capture member 74 has a V-shaped cross-section shape that is constituted the fixing unit 74a and the out-thrust wall 74c (FIG. 3). The fixing unit 74a and out-thrust wall 74c cross at an acute angle.

One side of the fixing unit 74a is fixed to the longitudinal sealing member 63, and another side is fixed to a mounting surface 51c of the developer container 51. Furthermore, the fixing unit 74a is plate that extends the long-side and short-side direction. The short-side direction is vertical to the long-side direction. The one side of the fixing unit 74a is fixed to the longitudinal sealing member 63 with an adhesive 76, for example, double-sided tape. Another side of the fixing unit 74a is fixed to the mounting surface 51c with an adhesive 77, for example, double-sided tape. A length L1 of the fixing unit 74a in the short-side direction may be shorter than a length of the longitudinal sealing member 63 in the short-side direction. In an installed condition of the development device 13, the edge part 74b is arranged so as to be below a bottom head of the developer chamber 51a, and an edge of the developer container 51 covers a part of the edge part 74b (FIG. 3).

The out-thrust wall 74c is arranged so as not to contact the photosensitive drum 11 and the developing roller 52. For example, the out-thrust wall 74c extends toward an abutting part A2 between the photosensitive drum 11 and the developing roller 52 (FIG. 3). And, the out-thrust wall 74c is away from the photosensitive drum 11 and the outer periphery 52a about 1 mm. The out-thrust wall 74c is plate that extends the long-side and short-side direction. As shown in FIG. 3, a length L2 of the out-thrust wall 74c is shorter by a set length than a length from the edge part 74b to the abutting part A2.

The longitudinal sealing member 63 is, for example a developing roller sealing film that is made of urethane and whose thickness is 0.2 mm. The capture member 74 is, for example, a developer scattering preventing film that is made of polyester and whose thickness is from 0.05 mm to 0.3 mm. For example, a length L1 is 5 mm, a length L2 is 5 mm, and a length L3 is from 6.5 to 7 mm. The L3 in the longitudinal sealing member 63 may be a length from the edge to the bend part (FIG. 3).

The first wall surface 71 and out-thrust wall 74c may be arranged on the way to a communication path that leads to an external of the development device 13 beginning at the abutting part A1.

The developer container 51 may be constituted of only one member, or may be constituted of more than two members. For example, the developer container 51 may include a developing frame 56, a side sealing member 57, and a side sealing member 58. The developing frame 56 corresponds to a top side, a bottom side, and an inner side in the sides of the developer chamber 51a. The side sealing member 57 may correspond to a left side in the sides of the developer chamber 51a, and the side sealing member 58 may correspond to a right side.

The longitudinal sealing member 63 may be fixed with an adhesive on the mounting surface 51c, and the fixing unit 74a may be fixed with an adhesive on the longitudinal sealing member 63. In other words, the longitudinal sealing member 63 may be fixed between the fixing unit 74a and the mounting surface 51c. In this case, the second wall surface 72 may correspond to the fixing unit 74a.

The capture member 74 may be constituted of a same member with the longitudinal sealing member 63 as one body.

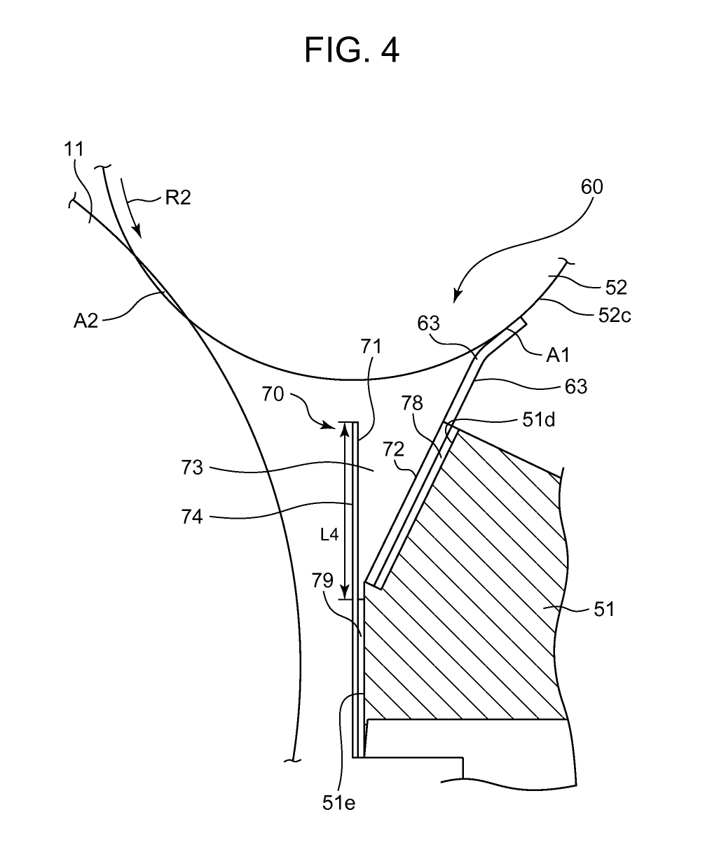

As shown in FIG. 4, the longitudinal sealing member 63 and the capture member 74 may be arranged separately. The longitudinal sealing member 63 is fixed to a mounting surface 51d with an adhesive 78, and the capture member 74 is fixed to a mounting surface 51e that is separated the mounting surface 51d with an adhesive 79 (FIG. 4). For example, a thickness of the capture member 74 may be from 0.05 to 0.2 mm, and the capture member 74 may be a plate and a developer scattering preventing film that is made of polyester. The capture member 74 may extend toward developing roller 52 the under the condition that the capture member 74 does not contact the developing roller 52. For example, the capture member 74 may be away from the developing roller 52 by 1 mm. A length L4 in the capture member 74 may be a length from the top edge to the adherend part which is fixed to the mounting surface 51e, and the L4 may be 4.5 mm. The part L4 in the capture member 74 extends above beginning at the adherend part (FIG. 4).

The second wall surface 72 may be constituted of a member that is different from the longitudinal sealing member 63. Thus, the containing space 73 may be formed by side(s) that are different from the longitudinal sealing member 63.

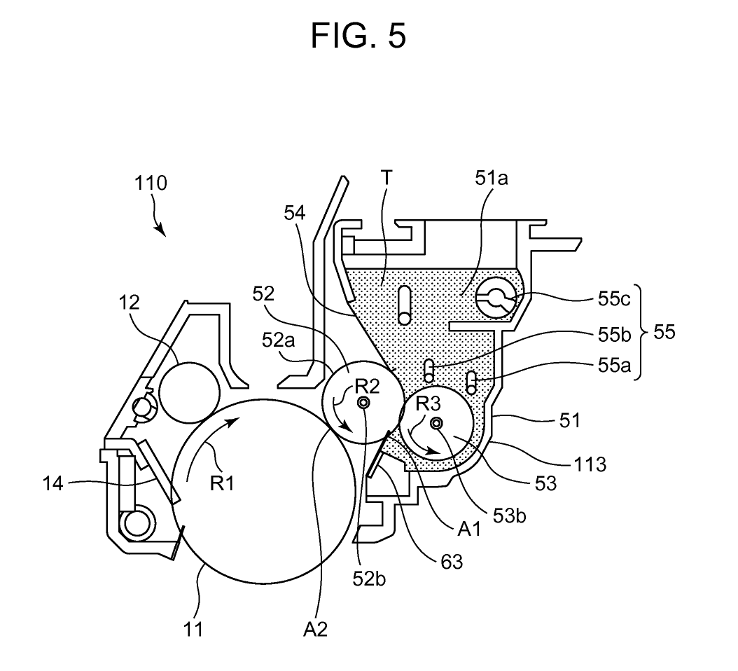

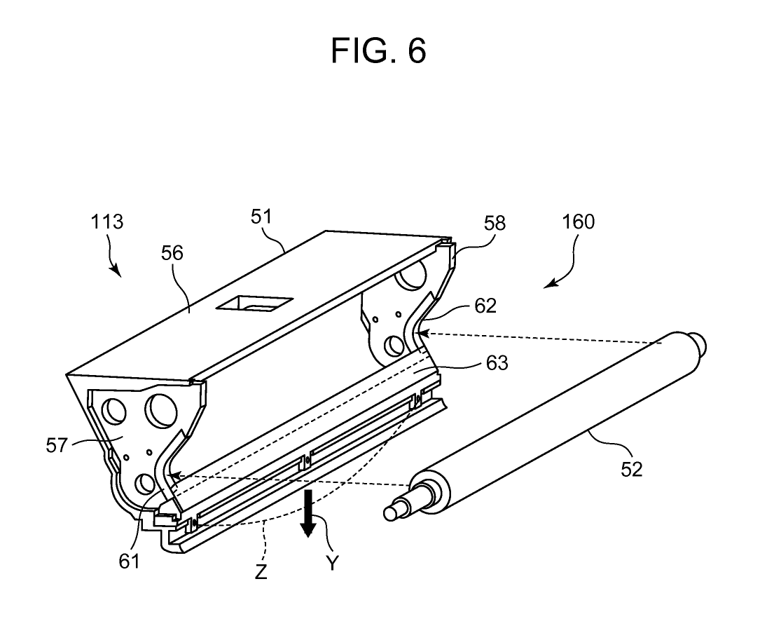

Referring the first embodiment and a comparative example, operations of the capture member 74 is described below. An ID unit 110 in the comparative example is same constitution of the ID unit 10 except for the ID unit 110 does not include the capture member 74. In FIGS. 5 and 6, common elements of structures between the comparing example and the first embodiment may be described by the same reference numbers in the first embodiment.

When the ID unit 110 is shocked by a falling during transportation and the developer container 51 or the developing frame 56 bends in a direction Y (FIG. 6), the longitudinal sealing member 63 that is fixed to the developer container 51 may bend, a contact pressure to the developing roller 52 in the center of the longitudinal sealing member 63 in the long-side direction may become lack, and the toner T in the developer chamber 51a may eject from between the developing roller 52 and the longitudinal sealing member 63. Furthermore, the ejected toner T may scatter out of the ID unit 110, and, for example, external members of the ID unit 110 may get dirty. In FIG. 6, a broken line Z schematically describes a degree of bending of the developer container 51.

On the other hand, when the ID unit 10 is shocked by a falling during transportation and the toner T in the developer chamber 51a ejects from between the developing roller 52 and the longitudinal sealing member 63, the ejected toner T may be captured by the capture unit 70 and the capture unit 70 may prevent from scattering out of the ID unit 10.

As described above, the development device 13 includes the capture unit 70 that captures the toner T that is ejected from between the developing roller 52 and the longitudinal sealing member 63. Thus, the capture unit 70 may prevent from scattering out of the development device 13 (or the ID unit 10) even though the toner T in the developer chamber 51a passes through the longitudinal sealing member 63.

Furthermore, the development device 13 includes the capture member 74. The capture member 74 is arranged out of the developer container 51 and around the developing roller 52, and the capture member 74 extends in the upstream direction of the outer periphery 52a so as to be a shape such like V-shape (FIG. 1). Thus, the capture member 74 may prevent from scattering out of the development device 13 (or the ID unit 10) even though the toner T in the developer chamber 51a passes through the longitudinal sealing member 63.

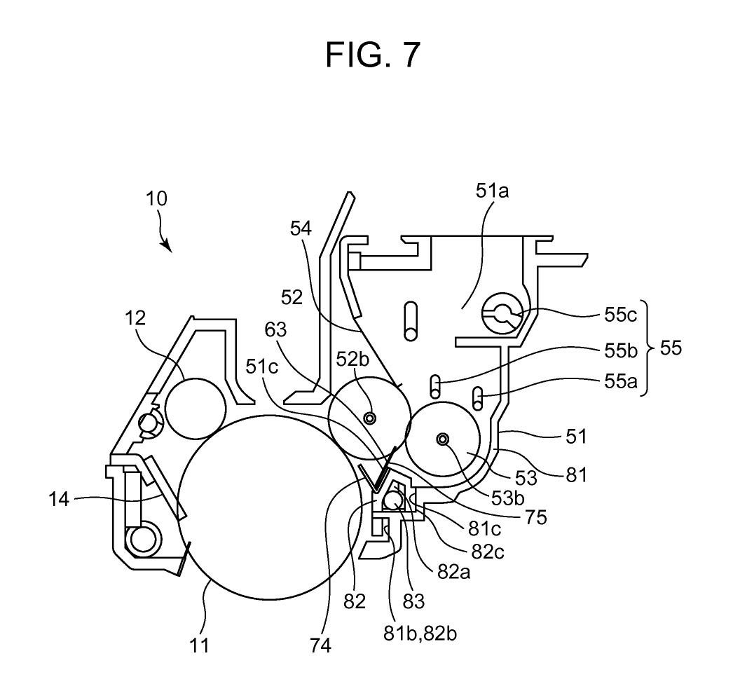

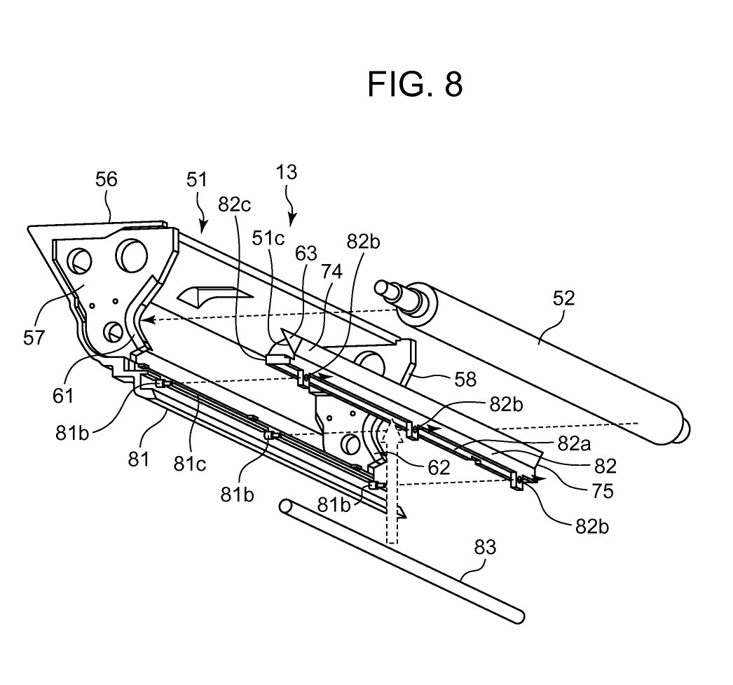

As shown in FIGS. 7 and 8, an ID unit in the second embodiment is described below. Common elements of structures between the first embodiment and the second embodiment may be designated by the same reference characters and be described by the same reference numbers. Thus, also referring with FIGS. 1 to 6, the common elements may be omitted or simplified here.

The development device 13 further includes a rigid bar 83 as a rigid member that suppresses the bending for the longitudinal sealing member 63. The rigid bar 83 is a member that extends in the long-side direction of the developing roller 52, and the rigid bar 83 is arranged in the developer container 51.

The developer container 51 includes a developer container main body 81 and a longitudinal sealing member holder 82. The rigid bar 83 is installed or furnished in the longitudinal sealing member holder 82.

The developer container main body 81 is a main member that consists of the developer container 51 mainly. The developer container main body 81 may be consisted of the developing frame 56 and the side sealing members 57, 58.

The longitudinal sealing member holder 82 is a member that supports the longitudinal sealing member 63, and a member that is attached to the longitudinal sealing member 63. Furthermore, the longitudinal sealing member holder 82 includes a mounting surface 51c, and the sealing member 75 that becomes unified the longitudinal sealing member 63 and the capture member 74 is fixed on the mounting surface 51c with an adhesive. The longitudinal sealing member holder 82 may be formed by molding.

The longitudinal sealing member holder 82 includes a containing unit 82a to contain the rigid bar 83. The containing unit 82a is formed a concave unit that has an aperture part on the downside. A size of the containing unit 82a is set so as to be installed the rigid bar 83 in the containing unit 82a (FIG. 7).

The longitudinal sealing member holder 82 is arranged the developer container main body 81. The longitudinal sealing member holder 82 has three engaging holes 82b and an adherend 82c, and the developer container main body 81 has three engaging pin units 81b and an adherend 81c. When the three engaging holes 82b engage the three engaging pin units 81b and the adherend 82c adheres to the adherend 81c with an adhesive, the longitudinal sealing member holder 82 is fixed the developer container main body 81.

The rigid bar 83 is formed in a columnar shaft and made of metal. The rigid bar 83 is not limited to the above description. The rigid bar 83 may be formed in a plate.

When the developer container 51 is assembled, the longitudinal sealing member holder 82 is attached the developer container main body 81 after the rigid bar 83 may be pressed into the containing unit 82a and the containing unit 82a contains the rigid bar 83 that is made of a metal shaft.

The developer container 51 is constituted of the developer container main body 81 and the longitudinal sealing member holder 82, but the developer container main body 81 and the longitudinal sealing member holder 82 are unified as one member. In this case, the rigid bar 83 is arranged at a position of the developer container 51 so as to suppress the bending for the longitudinal sealing member 63.

The development device 13 is arranged in the developer container 51, and includes the rigid bar 83 to suppress the bending for the longitudinal sealing member 63. Thus, a degree of the bending for the longitudinal sealing member 63 may be suppressed, and an amount of the toner T that passes through the longitudinal sealing member 63 may be kept lean.

Furthermore, when the longitudinal sealing member holder 82 contains the rigid bar 83, a degree of stiffness for the longitudinal sealing member holder 82 rises, and a degree of the bending for the longitudinal sealing member holder 82 may be suppressed significantly in a shocking of the development device 13. Thus, a degree of the bending for the longitudinal sealing member 63 may be also suppressed, and a leaking amount of the toner T from between the longitudinal sealing member 63 and the outer periphery 52a may be kept lean.

In this description, the parallel may mean not only a strict parallel but an almost parallel.

While the present invention has been particularly shown and described with reference to certain specific embodiments, it will be understood by those skilled in the art that the foregoing and other changes in form and details can be made therein without departing from the spirit and scope of the present invention.

The image forming apparatus 1 is the electrographic system of black-and-white. However, the image forming apparatus 1 is not limited to the electrographic system of the black-and-white, for example, the image forming apparatus 1 may be a electrographic system of color, a copy device, a fax device, a MFP (Multifunction Printer, Peripheral, or Product).

The capture unit 70 may include side walls at the side edges in the long-side direction. The side walls may prevent the toner from falling from the side edges even though the capture unit 70 sways from side to side. The capture unit 70 may include a sensor that detects an amount of the toner might be full in the capture unit 70.

The capture unit 70 includes the first wall surface 71, the second wall surface 72, and a capture area to capture the toner at a bottom of the capture unit 70, for example at around the edge part 74b. The first wall surface 71, the second wall surface 72, and the capture area form the V-shape (FIGS. 3, 4). However, the first wall surface 71, the second wall surface 72, and the capture area form, for example a U-shape, a basket-shape, and a Box-shape. The basket-shape and the Box-shape have a bottom plate in the capture area.

The first wall surface 71 may have an arch-shaped part to enlarge the containing space 73 or to enlarge a range of capturing the toner from above the containing space 73.

What is claimed is:

1. A development device, comprising:
a developer container that includes a developer chamber configured to contain a developer;
a developer carrier configured to hold the developer on a surface of an outer periphery and configured to rotate about an axis, and faces an electrostatic latent image carrier that carries an electrostatic latent image;
a longitudinal sealing member configured to contact the surface of the developer carrier in the long-side direction and configured to provide a seal of the developer from between the developer container and the developer carrier; and
a capture unit configured to capture the developer from between the longitudinal sealing member and the developer carrier.

2. The development device of claim 1, wherein the capture unit comprises:
a first wall surface arranged in an opposite side of a contact between the longitudinal sealing member and the developer carrier, and configured to extend in the long-side direction;
a second wall surface arranged so as to be closer to the contact than the first wall surface, configured to extend in the long-side direction, and formed containing space to contain the leaking developer from between the longitudinal sealing member and the developer carrier.

3. The development device of claim 2, wherein
the first wall surface extends in a direction to a far side of the contact from a side of the developer container, and does not contact the developer carrier and the electrostatic latent image carrier.

4. The development device of claim 3, wherein
the second wall surface extends in a direction to a far side of the first wall surface, and contacts the developer carrier.

5. The development device of claim 2, wherein
the second wall surface corresponds to a surface of the longitudinal sealing member.

6. The development device of claim 1, wherein the capture unit comprises:
a wall member to capture the developer arranged in an opposite side of a contact between the longitudinal sealing member and the developer carrier so as to create a space to capture the developer around an outer periphery of the developer carrier, and extended in a direction to a far side of the contact beginning at a side of the developer container.

7. The development device of claim 6, wherein
the wall member and the longitudinal sealing member are formed integrally, and the wall member extends beginning at an edge part of the developer container that is away from the contact between the longitudinal sealing member and the developer carrier.

8. The development device of claim 7, wherein the wall member comprises:
a fixing unit extended in a direction where the developer container exists and along the longitudinal sealing member; and
an out-thrust wall extended in an opposite direction beginning at the edge part, wherein a part of the fixing unit whose part does not contact the developer carrier is fixed at a mounting surface of the developer container, and
the out-thrust wall creates the space to capture the developer.

9. The development device of claim 1, further comprising:
a rigid member arranged to extend in the long-side direction of the developer container, and configured to suppress a bending for the longitudinal sealing member.

10. The development device of claim 9, wherein
the developer container includes a developer container main body that is formed a containing unit to contain the developer and a longitudinal sealing member holder that is attached to the developer container main body and supports the longitudinal sealing member, and
the rigid member is arranged in the longitudinal sealing member holder.

11. An image developing unit, comprising:
an electrostatic latent image carrier configured to carry an electrostatic latent image; and
the development device according to claim 1.

12. An image forming apparatus, comprising:
an electrostatic latent image carrier configured to carry an electrostatic latent image; and
the development device according to claim 1.

13. A development device, comprising:
a developer container that includes a developer chamber configured to contain a developer;
a developer carrier configured to hold the developer on a surface of an outer periphery and configured to rotate about an axis, and faces an electrostatic latent image carrier that carries an electrostatic latent image within the developer is carried to the electrostatic latent image;
a longitudinal sealing member configured to contact the surface of the developer carrier and configured to provide a seal of the developer from between the developer container and the developer carrier; and
a capture unit having a first wall, a second wall, and a lower end,
the first and second walls each having upper edges that are substantially closer to the developer container then the lower end thereby forming a capture area to capture developer that leaks from between the longitudinal sealing member and the developer container, or to capture a developer that is not transferred to the electrostatic latent image carrier.
